(19) United States
(12) Patent Application Publication
(10) Pub. No.: US 2024/0200209 A1
(43) Pub. Date: Jun. 20, 2024

(54) IN-SITU DEPOSITION-POLYMERIZATION FOR THE IMPREGNATION AND COATING OF CU-NANOPARTICLE ELECTRODES

(71) Applicant: Alliance for Sustainable Energy, LLC, Golden, CO (US)

(72) Inventors: Robert David ALLEN, Golden, CO (US); Kenneth Charles NEYERLIN, Denver, CO (US); Michael McGRAW, Lakewood, CO (US)

(21) Appl. No.: 18/544,107

(22) Filed: Dec. 18, 2023

Related U.S. Application Data
(60) Provisional application No. 63/433,347, filed on Dec. 16, 2022.

(51) Int. Cl. C25B 3/26; C25B 11/042

(52) U.S. Cl. CPC C25B 3/26; C25B 11/042

(57) ABSTRACT

Electrochemical CO₂ reduction is a promising technology to capture and convert CO₂ to valuable chemicals. Disclosed herein is the effect of anolyte on the effective morphology (i.e. ionic accessibility) of a CO₂ reduction cathode using electrochemical techniques and cell configurations that avoid the complexities related to co-electrolysis (oxygen evolution reaction at anode). When KOH is utilized as the anolyte the effective morphology of the cathode is enhanced, facilitating the CO₂ reduction kinetics via improved electrocatalyst accessibility

### CROSS-REFERENCE TO RELATED APPLICATIONS

This application is a continuation in part of and claims priority under 35 U.S.C. § 119 to U.S. Provisional Patent Application No. 63/433347 filed on 16 Dec. 2022, the contents of which are hereby incorporated in their entirety.

### CONTRACTUAL ORIGIN

This invention was made with government support under Contract No. DE-AC36-08GO28308 awarded by the Department of Energy. The government has certain rights in the invention.

### BACKGROUND

The efficiency of electrochemical conversion of CO₂ to useful products is a strong function of ion conduction at the electrode interface. Electrolysis of water is an important industry for the production of hydrogen gas.

Despite significant progress in the commercialization of carbon-neutral technologies, global carbon emissions has remained significant. In 2019, it was approximately 5.42 GtC/yr, with an average of 5.07±0.76 GtC/yr during the last 10 years. To compensate these huge emissions and keep the earth's temperature below the 1.5° C. limit recommended by the 2015 Paris Accord, CO₂ capture, conversion or sequestration is essential. Among different carbon capture and utilization technologies, electrochemical CO₂-reduction (CO₂R) is a promising approach. It can efficiently capture CO₂ from the effluent gases of heavy industries (e.g., fossil-fuel power plants, steel, cement factories etc.) and convert it to valuable chemicals like CO, C₂H₄, C₂H₅OH, HCOOH, etc. Historically, CO₂ reduction reactions (CO₂RR) were limited to low current densities due to the low solubility and diffusivity of CO₂ in liquid electrolytes. High current densities and Faradaic efficiencies of CO₂RR products were achieved using gas diffusion electrodes (GDE) with zero-gap cell configurations (no electrolyte layers separating electrodes from the membrane). A necessary step beyond flowing catholyte cells where high ohmic resistances limit the energy efficiency for such devices.

### SUMMARY

The provided methods and systems describe a process for the electrochemical CO₂ reduction to capture and convert CO₂ to valuable chemicals.

Without being bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 depicts a schematic of the experimental setups: (a) Multielectrode array (MEA) with a cathode exchange membrane (CEM) without KOH flow, (b) MEA with an AEM without KOH flow, and (c) with AEMs and KOH flow, (d) legends. The explosion and the cross symbols show the electrochemically active and inactive interfaces respectively.

FIG. 2 depicts Schematic of how capillary condensation of vapor makes more catalyst area electrochemically active. When relative humidity (RH) is low, condensation occurs inside the smaller pores first. With increasing RH, water fills up larger pores. Capacitance and ionic conductivity increase with increasing RH.

FIG. 3 depicts cathode capacitance vs RH curve shows the catalyst utilization in different experimental conditions. With KOH flow, the utilization was much higher.

FIG. 4 depicts ionic conductivity inside cathode vs RH for different experimental setups. The Y axis is plotted in logarithmic scale. Different types of conduction mechanisms are shown with different arrow styles. With KOH flow, conductivity was much higher.

FIGS. 5a, 5b depict overall morphological feature of a CO₂R electrode with a CEM and an AEM (with KOH flow): (a) maximum capacitances at different interfaces, showing that catalyst utilization is maximum in presence of KOH; and (b) maximum ionic conductivities in each domain. Ion conduction occurs dominantly through Nafion or KOH, not over the Cu-surface. The Y-scale is logarithmic.

FIG. 6 depicts an embodiment of a synthetic route to polymer coated Cu-nanoparticles.

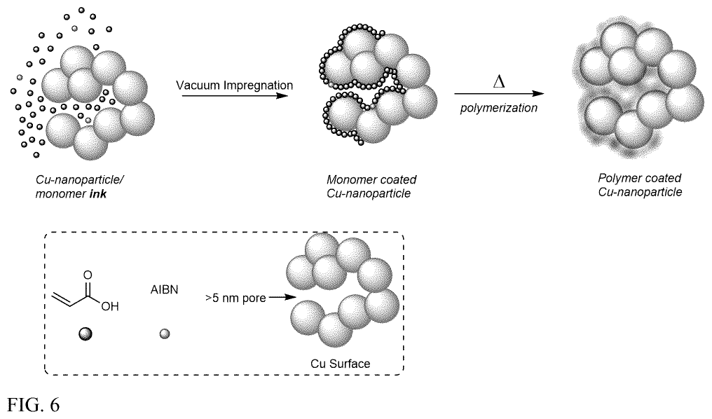

FIG. 7 depicts the electrochemical performance of CuNP-P1-PF and CuNP-P1-PF (6 wt %) electrodes for CO₂RR in a zero gap cell.

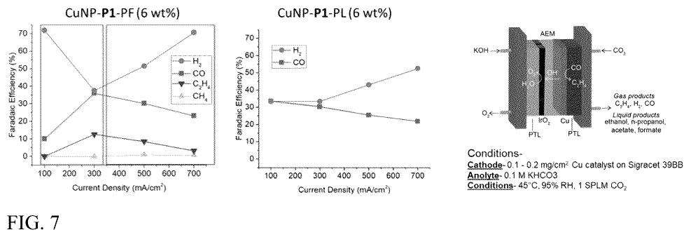

FIG. 8 depicts Coverage diagnostics for CuNP-P1-PL and CuNP-P1-PF electrodes (6 wt %).

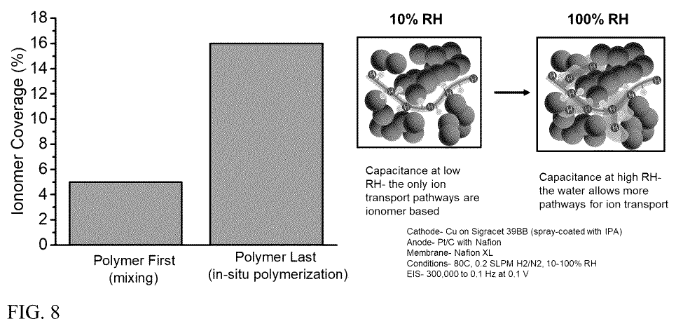

FIG. 9 depicts electrochemical performance of CuNP-P1-PL and CuNP-FEP-PF (0.5 wt %) electrodes for CO₂RR.

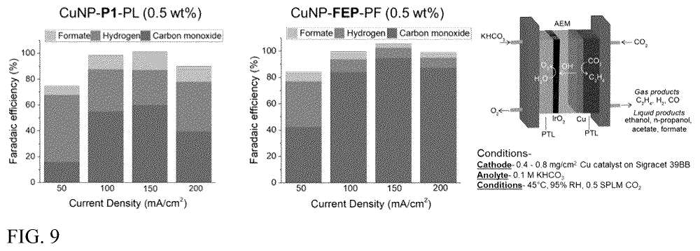

### DETAILED DESCRIPTION

Electrochemical CO₂ reduction is a promising technology to capture and convert CO₂ to valuable chemicals. The highest Faradaic efficiencies of CO₂ reduction products are achieved with zero-gap alkaline CO₂ electrolyzers with a supporting electrolyte at the anode (anolyte). Herein, we investigate the effect of anolyte on the effective morphology (i.e. ionic accessibility) of a CO₂ reduction cathode using electrochemical techniques and cell configurations that avoid the complexities related to co-electrolysis (oxygen evolution reaction at anode). Using 1 M KOH as the anolyte and a Cu gas-diffusion-electrode with low Nafion content as the model CO₂ reduction electrode, we find that the electrode capacitance (proxy for electrochemically active surface area) and the ionic conductivity inside the cathode increase approximately 4 and 447 times, respectively, in presence of KOH. Liquid anolyte wets the electrode's pore structure more efficiently than capillary condensation of feed water vapor. Moreover, the ionomer/electrocatalyst interaction, gleaned from ionomer coverage measurements assessed through AC impedance, inside the electrode is very low and the ionomer coverage distribution is highly fragmented. Surface ion conduction mechanisms inside the cathode are orders of magnitude lower than the bulk ion conduction in the presence of anolyte. This study shows that when KOH is utilized as the anolyte the effective morphology of the cathode is enhanced, facilitating the CO₂ reduction kinetics via improved electrocatalyst accessibility.

Disclosed herein methods of coating mesoporous Cu-nanoparticles with conducting polymer for electrocatalysis, in particular for electrochemical reduction of CO₂ and CO (CO₂RR). Disclosed herein are methods for in situ deposition-polymerization that forces monomer (small molecules) into the pores of a mesoporous Cu-nanoparticle to achieve a thorough and even coating over the surface. Then, the monomers a flash polymerized by either a thermal- or photo-induced initiation to leave a permanent polymer coating over the entire surface of the nanoparticle.

Since electrochemical CO₂ and CO reduction occurs on the surface of a Cu cathode, the surface area of the Cu-nanoparticles represents the quantity of catalytic sites available for CO₂RR. Therefore, etched Cu-nanoparticles designed with high porosity are employed to maximize surface area for maximum efficiency. The efficiency of a CO₂RR relies on the transport of protons generated at the anode to the Cu-cathode. This proton transport is facilitated by proton-conducting polymers. To this end, proton conducting polymers such as Nafion have often been employed. The conventional approach has been to physically mix polymer with Cu-nanoparticles in an ink, hoping the Cu will be homogenously coated. However, most of the Cu surface area exists inside narrow pores (greater than 5 nm) and cannot be coated with polymer simply because the polymer is too large to penetrate in. This results in a very small percentage of the surface actually being coated. Accordingly, disclosed herein are methods to produce an even polymer coating inside those pores, greatly increasing the number of active sites available for CO₂RR.

A typical zero-gap CO₂ reduction cell consists of three parts- CO₂ reduction cathode, a polymeric ion conduction membrane, and a water electrolysis anode. During CO₂ electrolysis, the potential at the cathode is negative with respect to the reversible hydrogen electrode (RHE), so, both CO₂RR and hydrogen evolution reaction (HER) occur at that potential. Anion exchange membranes are typically used to facilitate CO₂RR over HER. Often, an anolyte (KOH or KHCO₃) is circulated to improve the water-splitting kinetics at anode and ionic conductivity of the membrane and maintain an alkaline environment at the cathode to facilitate CO₂RR over HER. Some studies by others focused on the enhancement of CO₂RR kinetics by the anolyte. But there previously were no electrode-level studies that clearly analyzes the impact of the flowing anolyte on the cathode morphology. The morphological aspects include, but not limited to, catalyst utilization and ionic conductivity inside the electrode.

CO₂RR is strongly dependent on the local reaction environment at the catalyst-electrolyte interface like pH, concentration of the supporting electrolytes, type of cations in the supporting electrolyte, etc.

Moreover, different catalyst-electrolyte interfaces (e.g., catalyst-water, catalyst-electrolyte, catalyst-ionomer) co-exist within the cathode. As water acts as the proton donor for CO₂RR in alkaline environment, it can originate from both the anolyte and capillary condensation of the feed water vapor used to humidify CO₂. Previous studies indicate that anolyte provides the water responsible for CO₂RR during dry CO₂ feed. Moreover, it was also found that the CO₂RR performance does not depend strongly on the level of CO₂ humidification as long as an optimum level of anolyte circulation is maintained. However, if the feed gas is completely dry, carbonate and bicarbonate salts precipitate from the reaction of CO₂ and OH− resulting in higher Ohmic resistance in the cell. This indicates that during CO₂RR with in presence of an anolyte, the reaction dominantly occurs at the catalyst-anolyte solution interface. In addition, CO₂RR performance also depends on the catalyst-ionomer interactions, possibly due to catalyst utilization, stabilization of the reaction intermediates, and hydrophilicity of the ionomer side chain. However, it is not clear if the dependence of CO₂RR on the ionomer binder is an effect related to the overall electrode morphology (e.g., catalyst utilization), or improved reaction kinetics (e.g., stabilization of the reaction intermediates). Nafion is often used as the cathode catalyst layer binder material for its chemical stability and water sorption abilities, even though it does not conduct anions. It may also make the local catalyst environment more alkaline and facilitates CO₂RR over HE8 but precisely how much of the catalyst active area is covered by ionomer has never been assessed.

Disclosed herein are methods, compositions of matter and systems used to investigate the following issues—1) the effect of anolyte on catalyst utilization in the cathode, 2) ionic conductivity inside the electrode with and without anolyte, 3) ionomer coverage on the catalyst particles, and 4) estimated catalyst area interacting with the anolyte solution. As we focused solely on the morphological aspects of the cathode, we did not use any CO₂ electrolyzer setup. Instead, we used an anode that consisted of Pt supported on C, a membrane, and a Cu GDE with low Nafion content as the model CO₂RR electrode. Cu catalysts show good Faradaic efficiencies for C2 products. 1 M KOH was chosen as the anolyte. Comparing the catalyst utilization and ionic conductivity data in presence and absence of anolyte, we examine the role of anolyte on the cathode morphology. Based on these results, we also comment on the limitations of building a CO₂ electrolyzer without any flowing anolyte. In an embodiment, the cell and experimental design that enabled us to focus on the cathode's morphological aspects without any complexities of water electrolysis (oxygen evolution reaction or OER) at the anode.

In an embodiment, polymers can form a useful interface to improve both surface reactivity and selectivity on co-electrodeposited electrodes consisting of nano copper coated with various polyacrylamides with amino functionality. Without being limited by theory, we discovered that polymer structure was directly responsible for CO₂RR (CO₂ Reduction Reaction) selectivity towards C2 products. However, this approach is not scalable because of both the alkaline conditions employed (which causes a buildup of carbonates in the cell over time) and the Cu/polymer electrodeposition process employed.

In an embodiment, design of electrochemical cells disclosed herein includes the use of mesoporous copper nanoparticles as the cathode where CO₂RR takes place. This approach is more scalable than existing processes. Since CO₂RR occurs on the Cu-surface, the surface area of the Cu-nanoparticles represents the quantity of catalytic sites available for CO₂RR. Therefore, etched Cu-nanoparticles designed with high porosity can be employed to maximize surface area for maximum efficiency. However, CO₂RR also relies on the concentration of protons at the Cu-surface. Protons, which are generated from a variety of anodic processes, must be continuously transported to the Cu-cathode. To this end, proton conducting polymers such as Nafion have often been employed. The conventional approach has been to physically mix polymer with Cu-nanoparticles in an ink, hoping the Cu will be homogenously coated. However, most of the Cu surface area exists inside narrow pores (greater than 5 nm) and cannot be coated with polymer simply because the polymer is too large to penetrate in. This results in a very small percentage of the surface actually being coated. To support this conclusion, we disclose herein results that this typical nafion/Cu-nanoparticle system relies more on moisture for ion transport than the Nation.

Thus, our intention is to redesign the construction of the electrode so that the totality of the Cu-surface can be coated with ion-conducting polymers. To this end, we aim to coat Cu-nanoparticles, with monomer, instead of polymer thoroughly by a vacuum impregnation process. Monomers should be small and mobile enough to penetrate into the pores to evenly coat the entire surface area. Then, by some external stimulus, we will then trigger polymerization to yield fully coated Cu-nanoparticles. We will start with simple monomers such as acrylic acid, which is not known to be an exceptional ion conductor but should be rather simple candidate to benchmark the coating process.

We will then evaluate the PAA coated Cu-nanoparticles by SEM, cyclic voltammetry, and impedance spectroscopy to determine the efficacy and reliability of our coating process. If we can claim proof of concept, we will employ more sophisticated monomers containing functional groups known to be good proton conductors and facilitators of CO₂RR such as phosphonic acid and sulfonic acid groups (styrene-sulfonic acid as one commercially available example). If successful, we can then easily deploy a combinatorial approach to screen many ion-conducting polymers to study polymer structure/electrochemical performance relationships and ultimately improve CO₂RR kinetics/selectivity in a scalable and practical system. We also intend to explore the use of ion-conducting molecular glasses for this application. No polymerization is required in this case, but this compound type has been shown to be useful in the filling of very small pores—quite commonly found in semiconductor fabrication.

### Methodology and Cell Configurations

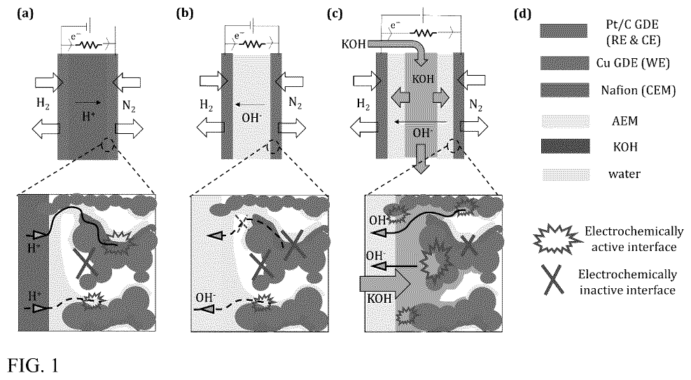

In an embodiment, we used a Cu GDE with low Nafion content as the model CO₂RR electrode in this study because of its high FE toward C2 products. To understand the role of anolyte (KOH in this study) on the CO₂RR electrode, we measured the catalyst utilization, catalyst-ionomer interactions, and ionic conductivities inside the electrode using different cell configurations summarized in FIG. 1. Catalyst utilization was measured using electrode capacitance. EIS was used as the main experimental tool to calculate capacitance and ion-transport resistances. We fed the Pt/C anode with H₂ and the Cu GDE with N₂ gases. H₂ at Pt enabled us to control the potential on the cathode with precision and provided a good reference electrode. It was also the counter electrode. By using a Pt reference/counter electrode, we also avoided the complexities of OER that occurs in a practical CO₂ electrolyzer. Using N₂ at the cathode, we avoided the complexities of Faradaic reactions to a great extent. In practical conditions, Faradaic reactions like oxide formation on Cu and oxidation of H₂ that crosses over the membrane do occur and are accounted for in the data analysis.

The effect of anolyte KOH on the morphology of the cathode was determined in the following way—first, we measured the capacitance and ion-transport resistance of the electrode without any anolyte. Both CEMs and AEMs were used. The configurations with a CEM and an AEM are shown in FIG. 1a and 1b respectively. Then, we repeated the experiments with the same AEM but in presence of flowing KOH as depicted in FIG. 1c. To avoid flooding in the anode and ensure adequate H₂ accessibility, the anolyte chamber was separated from the Pt/C electrode by another membrane of the same kind. Comparing these properties in presence and absence of KOH, we determine the role of KOH on the Cu GDE. These setups avoid the OER-related complexities of a CO₂ electrolyzer and elucidates the morphology of the CO₂R cathode.

Disclosed herein are how these different experimental conditions (FIG. 1a-c) reveal different electrochemical interfaces and ion-conduction mechanisms inside the Cu GDE. They are shown in the relevant zoomed-in boxes (FIG. 1a-c). When a CO₂ electrolyzer operates, different electrochemical interfaces and ion-transport mechanisms become active inside a CO₂RR GDE. The experimental setups in FIG. 1a-c help to determine them. Table 1 describes the major and minor active interfaces and ion-conduction mechanisms for different cell configurations in FIG. 1. Detail of the setup and experimental procedure are provided in the Experimental section.

TABLE 1: Active interfaces and ion-transport mechanisms for different setups in Figure

| | | Electrochemically | Electrochemically | Ion-conduction | Ion-conduction |
|---|---|---|---|---|---|
| Setup | | active interfactes | active interfactes | mechanisms | mechanisms |
| label | Setup details | Major | Minor | Dominant | Secondary |
| a) | Cu GDE with CEM, | Cu—H₂O | Cu—Nafion | H⁺ conduction | Surface |
| | no anolyte (KOH) | | | via Nafion | conduction of |
| | flowing | | | | H⁺ ions |
| b) | Cu GDE with AEM, | Cu—H₂O | Cu—Nafion | Surface | H⁺ |
| | no anolyte (KOH) | | | conduction of | conduction |
| | flowing | | | OH⁻ ions | via Nafion |
| c) | Cu GDE with | Cu—KOH | Cu—Nafion | Bulk ion- | 1. H⁺ and K⁺ |
| | AEM and anolyte | | Cu—H₂O | conduction | ion conduction |
| | (KOH) flowing | | | through KOH | through Nafion |
| | | | | | Surface ion |
| | | | | | conduction |

In the CEM cell configuration (FIG. 1a), H+ conduction occurs inside the electrode through the Nafion chains as well as through water confined inside the pores. Although ionic conductivity is very low in bulk water, it is several orders higher in magnitude for confined water. The latter is often called surface conduction of ions where the term ‘surface’ refers to the local catalyst particle-water interface. This phenomenon has been studied from fundamental electric double layer perspective as well as in porous electrodes. From the impedance measurements at low and high relative humidity (RH) of the cathode gas feed, we calculate—1) the ionomer coverage, and 2) H+ conductivity inside the electrode. The ionomer coverage is calculated by comparing the electrode capacitance at very low and high RH. The following equations apply for this setup:

$$C ( RH ) {\vert}_{CEM} = C {\vert}_{Cu - Nafion} + C ( RH ) {\vert}_{Cu - {H}_{2} O} \qquad ( 1 )$$

$$κ ( RH ) {\vert}_{CEM} = κ ( RH ) {\vert}_{{H}^{+} , Nafion} + κ ( RH ) {\vert}_{{H}^{+} , Cu - {H}_{2} O} \qquad ( 2 )$$

In Eqn. (1), C(RH)|_{CEM} refers to the total capacitance measured with a CEM at any given RH. C|Cu-Nafion and C(RH)|_{Cu-H2O} are the capacitances from the Cu-Nafion and Cu-water interfaces respectively. We assumed that the capacitance at the Cu-Nafion interface does not strongly depend on RH because of low Nafion loading in these Cu electrodes. The term Cu—H₂O refers to the Cu-water interface where water is formed due to capillary condensation of the vapor used to humidify the cathode feed. In Eqn. (2), k(RH) is the overall ionic conductivity through the electrode at any given RH. K(RH)|CEM. K(RH) |H⁺, Nafion is the ionic conductivity of H+ though the Nafion chains and K(RH) | H+Cu-H2O, Nafion is the surface conduction of H+. The total H+ conductivity is the sum of H+ conductivities occurring via these parallel channels.

In the second cell set-up (FIG. 1b), we assembled the MEA with an AEM without any flowing anolyte. In this configuration, OH− conduction in the electrode predominantly occurs at the Cu-H2O interface as the bulk ionic conductivity of water is very low, and Nafion transports cations (e.g., H+ or K+). For the AEM case, we have

$$C ( RH ) {\vert}_{AEM} = C {\vert}_{Cu - Nafion} + C ( RH ) {\vert}_{Cu - {H}_{2} O} \qquad ( 3 )$$

$$κ ( RH ) {\vert}_{AEM} \approx κ ( RH ) {\vert}_{{OH}^{-} , Cu - {H}_{2} O} \qquad ( 4 )$$

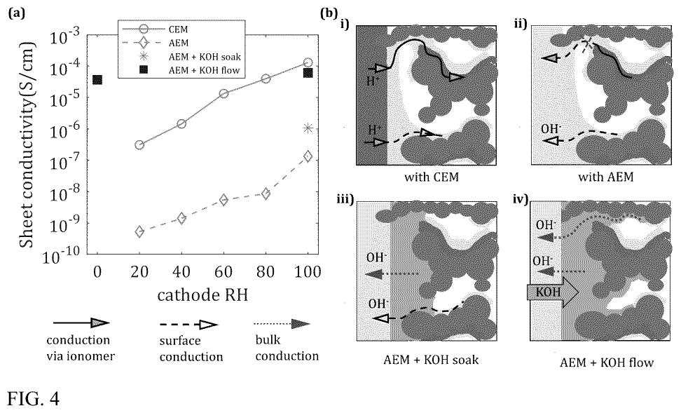

Eqn. (1) and (3) are approximately equal, as capacitance comes from the electroactive area of the catalyst layer irrespective of the conducting ions. Eqn. (4) only assumes the dominant ion-conduction mechanism, i.e., OH− conduction over the Cu surface. In principle, Nafion chains can also conduct H+, but in this case, a bipolar-junction would appear inside the electrode as it is in contact with an AEM. The water splitting reaction has to occur at the water-Nafion junction. The data (FIG. 4) shows that its effect is much smaller in magnitude than the dominant mechanism, so, its contribution is negligible.

After investigating the Cu electrode properties without KOH in the first two cell configurations, the electrolyte was introduced in the third step (FIG. 1c). In this set-up, KOH was flowed in a chamber created between the anode and the cathode (details in the Experimental section). The KOH chamber was kept separated from both electrodes by two AEMs. KOH crossed through the AEM to penetrate inside the Cu GDE. This mimics the situation in a practical CO2 electrolyzer where KOH fed as the anolyte crosses over to the cathode through the anode and the membrane. The KOH crossover rate is strongly dependent on the properties of the specific AEM and is not universal. We have the following relations:

$$C ( RH ) {\vert}_{AEM + KOH} = C {\vert}_{Cu - Nafion} + C ( RH ) {\vert}_{Cu - {H}_{2} O} + C {\vert}_{Cu - KOH} \qquad ( 3 )$$

$$κ ( RH ) {\vert}_{AEM + KOH} \approx κ ( RH ) {\vert}_{{K}^{+} , Nafion} + κ ( RH ) {\vert}_{{OH}^{-} , Ci - {H}_{2} O} + κ {\vert}_{KOH} \qquad ( 4 )$$

In Eqn. (5) the term C|Cu-KOH refers to the Cu-KOH solution interface. This is the extra interface in presence of KOH. Similarly, in Eqn. (6), kk|KKK refers to the conductivity through the KOH phase in the electrode layer. Both these quantities are RH independent as they are liquid in nature. The conductivity with KOH flow can be assumed to be bulk ionic conductivity and both K+ and OH− contribute to the process. K(RH)| K+, Nafion is the conduction of K+ through Nafion chains. It is important to note that in presence of KOH solution, Nafion chains can conduct both H+ and K+. As this setup has an AEM, the amount of H+ present in the electrode is significantly less than that with a CEM (FIG. 1a). Therefore, the ionic conductivity of Nafion within the Cu electrode will primarily result from K+ conduction.

An additional electrode set-up was used, where there was no flowing KOH, but the electrode was pre-soaked in KOH before being assembled in the cell. KOH stuck to the electrode, bridged the microscopic gap between the membrane and the GDE, and reduced the overall Ohmic resistance of the cell. When we compare the results of this setup with that from FIG. 1c, we can determine the effect of KOH cross-over through the membrane and penetration inside the GDE.

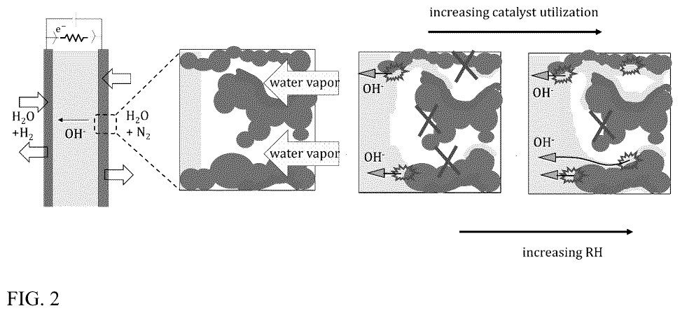

Next, we explain how capillary condensation effect can be used to determine the electroactive catalyst area. If water vapor is mixed with the feed gas (H₂ or N₂), upon entering the electrode, it will condense to form water inside those pores whose size are less than a certain radius (rₚₒᵣₑ) determined by the Ostwald-Freundlich equation, a variation of the Kelvin equation. For low RH, vapor condenses to form water inside smaller pores. When RH is increased, vapor condenses into larger pores. The pores that have liquid water inside them may become electrochemically active, as ion conduction (H+ and OH−) can occur in those domains. With increasing RH, more pores become electrochemically active. Experimentally, this implies that capacitance and ionic conductivity will increase with RH. This is explained schematically in FIG. 2.

This phenomenon is also important from another reason. As mentioned before, water acts as the source of protons for both CO₂RR and HER in alkaline environment. In a CO₂ electrolyzer cell, there are two possible sources of water—1) the anolyte KOH solution, and 2) water formed by capillary condensation from the feed vapor. Experimental evidence suggest that the anolyte KOH solution is the principal source of water. By comparing the experimental results with and without KOH, this will be verified later.

As mentioned earlier, EIS was performed to measure the capacitance and ionic conductivity of the Cu GDE. The data were fitted with a transmission-line model. The overall measured impedance takes the form:

$${Z}_{net} = {Z}_{membrane} + {Z}_{cathode} + {Z}_{DM} \approx {R}_{Ω} + j ω L + \sqrt{{R}_{CL} {Z}_{int}} \times coth ( \sqrt{\frac{{R}_{CL}}{{Z}_{int}}} ) \qquad ( 7 )$$

The impedance from the anode can be assumed to be 0. In Eqn. (7), RΩ is the Ohmic resistance (also called high-frequency resistance or HFR) which is the sum of the ion-conduction resistance through the membrane (H+ in case of CEM, and OH− for AEM) and electronic resistance through the catalyst layer, the diffusion media (abbreviated as DM), the flow fields, and the current collectors. The contribution of the electronic resistance is usually insignificant unless a significant surface oxidation occurs on the DM or flow fields. In our setup, humidified H₂ is fed at the anode where it is oxidized. As a result, the surface oxide effect on electronic conductivity can be neglected. In a practical CO₂ electrolyzer, the electronic resistance could be high due to oxide formation on the anode flow field and the diffusion medium. RΩ is not particularly relevant to understand the cathode morphology. Zᵢₙₜ denotes the interfacial resistance

$$( {Z}_{int} = {R}_{CT} / [ 1 + j ω {CR}_{CT} ] )$$

at the catalyst-electrolyte interface inside the electrode. C denotes the electrode (sheet) capacitance of the cathode and RCT is the Faradaic charge transfer resistance. For unsupported catalyst (as disclosed herein), the capacitance acts as a good measure as the active catalyst area. All EIS experiments were performed at the same potential (100 mV DC and 20 mV AC root mean square). RCL is the ion-transport resistance (H+ in case of CEM, and primarily OH− for AEM) inside the cathode as known as the electrode sheet resistance. ‘j’ is the imaginary number (√−1). ω=2πν, where ν is the angular frequency of the oscillation (measured in Hz). L is the inductance (from all the metallic parts in the circuit).

### Results and Discussions

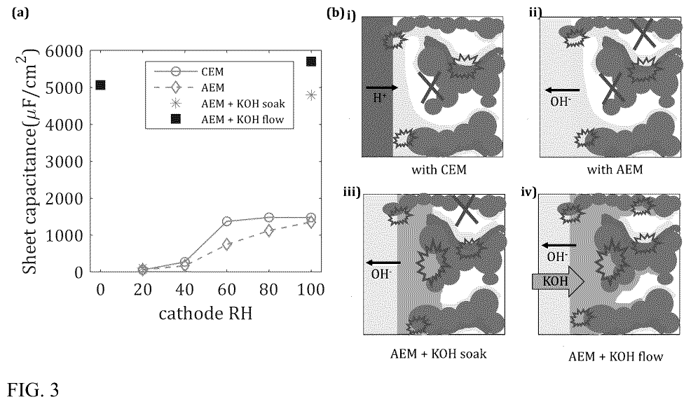

EIS experiments were performed with all configurations shown in FIG. 1a-c. First, we show how the capacitance changed with RH with and without KOH in FIG. 3-3(a) shows the plot of capacitance vs RH, and FIG. 3(b) shows schematic of active interfaces for different settings.

Data in FIG. 3 show that for both AEM and CEM, the capacitance increases with RH. N2 was fed at cathode to ensure that the electrode charging is dominantly capacitive. However, Faradaic reactions still occur due to the presence of water and oxidation of the H₂ that crosses through the membrane. For this study, Faradaic charge transfer resistance values are not directly relevant. At very low RH, the electrode does not have much condensed vapor and catalyst-ionomer interface was the active electrochemical interface. This is the reason why capacitance values at low RH were very similar for both AEM and CEM since similar Cu electrodes were used in these two cell configurations. In the intermediate RH range, capacitance was higher for CEM than AEM, perhaps because Nafion (CEM) has better water sorption than AEMs and the actual water content in the electrode will vary depending on the water-sorption properties of the membrane. At very high RH, the capacitance values for both CEM and AEM converge to a similar value as anticipated. This shows the maximum catalyst utilization that can be achieved by capillary condensation of the feed water vapor, and it is independent of the membrane. The ionomer coverage can be calculated, both for CEM and AEM, by taking the high and low RH limits of Eqn. (1) or (3) as:

TABLE 2
Ionomer coverage of Cu

| | C(RH = 20) | C(RH = 100) | Ionomer |
|---|---|---|---|
| Membrane | (μF/cm²) | (μF/cm²) | coverage |
| CEM (Nation XL) | 55.24 | 1475.76 | 3.74% |
| AEM (Ionomr) | 57.45 | 1350 | 4.26% |

In both configurations, ca. 4% of the catalyst active area is covered by ionomer (Nafion). The similarity of the electrode capacitances suggests minimal electrode variability using this specific electrode fabrication method.

We also repeated the experiment at 100% RH with an electrode that was presoaked in 1 M KOH solution. Cell ohmic resistance with GDE is typically higher than catalyst-coated membranes (CCM) due to the lack of strong contact between the membrane and the electrode. This makes ion-conduction between the GDE and the membrane less efficient. When the MEA was assembled with the wet GDE, the KOH film acted as ion-bridge between them. This decreased the overall ohmic resistance of the cell and improved the catalyst utilization by penetrating inside the GDE due to the capillary effect.

Next, we describe the physical significance of the measured capacitance values when KOH was flowing (FIG. 1c). During this experiment, the electrode was not pre-soaked with KOH. So, it did not have any KOH initially. Any KOH that entered the GDE must have crossed over through the AEM separating it from the KOH chamber, mimicking the actual situation in a CO2 electrolyzer. The measured capacitance was 5064.52 μF/cm² for dry N₂ feed and 5702.69 μF/cm² for 95% RH gas feed. These values were corrected for the capacitance of a bare GDL with flowing KOH. The capacitance increased only by 12.6% for 95% increase in RH. This result is of tremendous importance. It implies that when KOH is flowing, catalyst utilization is much higher than the case when it is not flowing. Secondly, with flowing KOH, the feed RH does not contribute appreciably to catalyst utilization.

Using Eqn. (5), we can put C(RH=100)AEM+KOH=5702.69 μF/cm2. Also, at 0% RH, C|Cu-H2=O. So, C|Cu-KOH =C(RH=0)|AEM+KOH-C|Cu-Nafion=(5064.52−57.45) μF/cm²=5007.07 μF/cm². (Table 1, AEM). Like ionomer-coverage, one can also calculate the portion of catalyst active area covered by KOH solution, using Eqn. (5) to be:

$$KOH coverage = \frac{C {\vert}_{Cu - KOH}}{C ( RH = 100 ) {\vert}_{AEM + KOH}} \frac{5007.07 μ F / {cm}^{2}}{5702.69 μ F / {cm}^{2}} \times 100 = 87.8 \%$$

Using Eqn. (5) and data in FIG. 3, we can tabulate the relative abundance of different interfaces inside the CO₂R electrode (with AEM membrane) in the following table:

TABLE 3
Relative abundance of different interfaces:

| Interface | Mathematical symbol used | Percentage |
|---|---|---|
| Cu-Nafion | C\|_{Cu-Nafion} | 4.26% |
| Cu—H₂O (capillary condensed) | C(RH = 100)\|_{Cu—H2O} | 7.94% |
| Cu—KOH solution | C\|_{Cu—KOH} | 87.8% |

This result strongly indicates that Cu-KOH interface is the most dominant for Faradaic reactions (both CO₂RR and HER). Similar results were also found for the anode of an alkaline electrolyzer5. This also indicates that the liquid KOH wets the pore-space inside the electrode better than capillary condensation. Another important comparison can be done between the capacitance values during KOH soak and KOH flow. During KOH soak, the capacitance was 4657.13 μF/cm² (corrected for a bare GDL), which is 81.66% of the capacitance measured during KOH flow. This indicates that during soak, the KOH solution penetrated the Cu GDE significantly due to the capillary action. The calculation in Table 2 neglects the difference in dielectric properties of these interfaces, i.e., Cu-Nafion, Cu—H₂O, and Cu-KOH. The results, however, do not change by more than a few percentages.

Disclosed herein is the ionic conductivity inside the electrode vs RH data for different experimental conditions in FIG. 4-FIG. 4(a) shows the numerical values, 4(b) shows the ion-conduction mechanisms for different experimental setups, and 4(c) shows the legends. The Y-axis (electrode conductivity) is plotted in logarithmic scale as it strongly depended on the feed RH, when no KOH was present. This conductivity trend with hydration is also well-known for Nafion membranes. From the EIS data, area specific sheet resistance was calculated by fitting it with the high-frequency limit of the transmission-line model. Then, conductivity was calculated with the knowledge of electrode thickness. The thickness was measured by micro-XCT.

In FIG. 4(a), the sheet conductivity increased with increasing RH. For CEM setup (FIG. 1a), the sheet conductivity increased from about 1.04×10⁻⁶ S/cm at 20% RH to about 4.39×10⁻⁴ S/cm at 100% RH. For the AEM setup (FIG. 1b), the sheet conductivity was much lower, but increased similarly from about 1.79×10⁻⁹ S/cm at 20% RH to about 4.54×10⁻⁷ S/cm at 100% RH. Ionic conductivity in AEM configuration was orders of magnitude lower, for any given RH, because of the difference in ion-conduction mechanism. In the CEM configuration, H+ conduction can occur both via Nafion chains and along the Cu surface (covered by water). So, even when the RH was low, Nafion chains could still conduct H+, although the cationic conductivity of Nafion was less for reduced RH. The situation is depicted in FIG. 4(a)i. In the case of AEM (FIG. 4(b)ii), the only available mechanism for OH− conduction was along the Cu surface. H+ conduction through the Nafion channel can also occur in principle, however, as OH− conducts through the membrane, local conservation of charge dictates that a bipolar junction would appear somewhere inside the electrode where water dissociation must occur. The order of magnitude difference in the conductivities in these two configurations (CEM and AEM) indicate that the secondary ion-conduction mechanism (via surface conduction or) is much weaker. From Eqn. (4), we can put K(RH=100)|OH−, Cu—H₂O=4.54×10⁻⁷ S/cm.

Now, we make a simple assumption that at any hydration level, the ratio of surface conductivity of H+and OH− is approximately equal to the ratio of their bulk conductivities at infinite dilution. The rationale behind this assumption is the following: surface ionic conductivity is influenced by local electric fields that arises due to the charge on Cu (potentiostatic charging). Assuming similar magnitudes of charging in these two setups (AEM and CEM), it is reasonable to expect that the conductivities would follow similar ratio as in dilute solution. Molar conductivities (Λ) of H+ and OH− at infinite dilution are 349.65×10⁻⁴ m² S/mol and 198×10⁻⁴ m² S/mol respectively. With this assumption, we have:

$$κ ( RH ) {\vert}_{{H}^{+} , Cu - {H}_{2} O} = κ ( RH ) {\vert}_{{OH}^{-} , Cu - {H}_{2} O} \times \frac{{Λ}_{{H}^{+}}}{{Λ}_{{OH}^{-}}} S / cm$$

Next, we explain the conductivity data with KOH soak. When the electrode was soaked in KOH (no KOH flow), the sheet conductivity was 3.59×10⁻⁶ S/cm, which is almost 10 times the conductivity found when the electrode was not soaked with KOH. As explained after Table 2, while soaking, KOH made more catalyst particles electrochemically active by—1) acting like an ion-bridge between the GDE and the membrane, and 2) penetrating inside and making more catalyst particle electrochemically active. This is explained schematically in FIG. 4(b)iii.

In the setup with KOH flow, we measured the conductivity for two RH values only—0% RH and 95% RH. FIG. 4(a) shows that the values are much higher than one without any flow—1.22×10⁻⁴ S/cm for 0% RH and 2.03×10⁻⁴ S/cm for 95% RH. Even for 0% RH, the ionic conductivity is much higher in magnitude than the case FIG. 4(b)ii. It's because the ion-conduction is dominated by the conductivity of 1 M KOH in the pore-space. The specific conductivity of 1M KOH at 60° C. is 0.3222 S/cm³ whereas the specific conductivity of DI water is <5×10⁻⁸ S/cm. Moreover, 1 M KOH dissociates very efficiently to K+ and OH− ions (base dissociation constant Kb=0.31634). From these data, we have

$$κ {\vert}_{KOH} ≫ κ ( RH ) {\vert}_{{OH}^{-} , Cu - {H}_{2} O} .$$

So, bulk conduction through KOH was orders of magnitude higher than surface conduction of OH−.

For 95% change in RH in the flowing KOH case, the ionic conductivity increased by 0.8×10⁻⁴ S/cm, which is three orders of magnitude higher than the surface conductivities found for the configuration in FIG. 4(b)ii (˜10⁻⁷ S/cm). The order of magnitude is close to the one found for FIG. 4(b)i, indicating that the extra conductance is through Nafion. One possible reason is the following: KOH can penetrate those pores only where the pressure is higher than the capillary pressure. Vapor on the other hand, can penetrate any network of pores that are connected. If Nafions chains exist in those pores that are not accessible to KOH but accessible to vapor, then those chains would swell by absorbing the vapor, and form ionically connected networks with pore domains where KOH exist. Those Nafion chains would conduct K+ ions. There is no source of H+ in this case as it's an alkaline environment, so H+ does not contribute to the conduction. So, in Eqn. (6), we put

$$κ ( RH ) {\vert}_{{H}^{+} , Nafion} = 0 and κ ( RH ) {\vert}_{{K}^{+} , Nafion} \approx 0.8 \times {10}^{- 4} S / cm .$$

Finally, we tabulate the ionic conductivities in alkaline environment (with AEM) in presence and absence of KOH:

TABLE 4
Electrode conductivity in presence or absence of KOH:

| Experimental setup | Electrode conductivity |
|---|---|
| Electrode with AEM and no KOH | 4.54 × 10⁻⁷ S/cm |
| Electrode with AEM and flowing KOH | 2.03 × 10⁻⁴ S/cm |

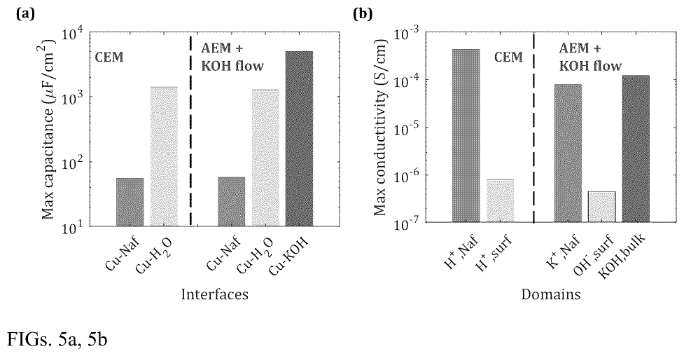

Comparing the data for AEM with and without flowing KOH, three conclusions can be drawn—1) approximately 4.22 times more catalyst area is utilized, 2) almost 87.8% of the catalyst area is in contact with KOH, and 3) the electrode conductivity is about 2-3 orders of magnitude higher when KOH is flowing. This clearly proves that KOH improves the morphology of CO₂R electrodes with low amount of Nafion as the binder material. We summarize the data, both capacitances and ionic conductivities in different domains FIG. 5.

We calculate the porosity of the electrode in the following way: volume of the electrode Velectrode=25 cm²×16.9 μm. The Cu mass loading MCu=2.66 mg/cm² (from XRF). The density of Cu ρCu=8.96 gm/cm³ at 300 K. So, the volume occupied by Cu inside the electrode VCu=6.696×10⁹ μm³. Thus, the volume fraction of Cu εCu=VCu/Velectrode =0.16. The specific gravity of D2020 ionomer used for the Cu GDE=1.02 (spec sheet). Following similar argument, the ionomer volume fraction εᵢₒₙₒₘₑᵣ=0.09. So, the void fraction inside the Cu GDE was ε_{void}=1−ε_{Cu}−εᵢₒₙₒₘₑᵣ=0.75.

Estimating the porosity in this way, we can calculate the tortuosity in the ionomer and pore-space distribution. Moreover, this is an electrode specific property, i.e., it depends on the electrode composition. From the calculations, the ionomer tortuosity in the maximum hydration (100% RH) was 19.2. In 20% RH, it was 347. When RH increases, Nafion absorbs water, swells, and form a better-connected network. This is why the tortuosity decreases with increasing RH. The high tortuosity, even at 100% RH, indicates that ionomer distribution inside the electrode is highly fragmented. This may imply a strong interaction between Cu and Nafion ionomer, which may decrease if a catalyst support is used. In addition to being a binder and making the local environment alkaline, Nafion seems to interact with the Cu particles strongly.

While it has already been shown that KOH improves OER kinetics, catalyst utilization inside the anode, and membrane conductivity in an AEM water electrolyzer, and the impact of anolyte KOH in facilitating the CO₂RR kinetics is already presented, the methods, compositions of matter and systems disclosed herein enhances the communities understanding of the relationship between anolyte KOH and the electrochemical properties of the cathode in zero-gap CO₂R cathodes. Historically, since commercially available anion exchange binders have not been chemically and mechanically as stable as the cation exchange binders like Nafion and can be difficult to incorporate as well dispersed components of even fuel cell electrodes, Nafion has often been utilized as the binder of choice. In fact, it was even postulated that the hydrophobic nature of Nafion's backbone also helps CO₂ transport and maximizes the catalyst active area, though our current findings highly the need to decouple chemistry and morphology when swapping ionomeric binder material for CO₂R devices. Nevertheless, the catalyst utilization and ionic conductivity inside the CO₂R electrode will be much higher if flowing KOH is used in the system. To the best of our knowledge, there is only one work where the authors claimed to operate a CO₂ electrolyzer with an in-house AEM and anion-exchange binder that resulted in high FE of CO₂RR products, low overpotential, and 100 hours of stability. However, little is known about the electrocatalyst/ionomer interactions for such a system which may depend just as much on the processing of the materials as well as their inherent properties. Nevertheless, unless pathways are pursued to enhance cathode catalyst utilization (ionic accessibility) at low RH, anolyte flow appears to be essential for CO₂ electrolyzers to increase catalyst utilization, ionic conductivity, and perhaps product selectivity inside the CO₂R electrodes.

In an embodiment, disclosed herein is a design process by which CuNPs could be reliably and uniformly coated with the functionalized polymer. To this end, we envisioned a scenario where monomer (instead of polymer) could be mixed with CuNPs in an ink followed by evaporation of solvent to produce a monomer coated CuNP. The monomer coating the CuNP could then be triggered by some stimulus (in this case heat) to polymerize over the surface of the CuNP (Polymer Last, or PL). For this concept demonstration, we chose free radical polymerization (FRP) of (meth)acrylamides, as they are diversely functionalized and commercially available, are electrochemically stable, and have been shown in the past to facilitate CO₂RR.ⁱ Additionally, FRP can be triggered by the thermal decomposition of initiators such as azobisisobutyronitrile (AIBN) giving us the convenience and control to initiate polymerization only once the monomer deposition onto the CuNP has been completed.

After screening many monomer choices, we settled on 3-dimethylaminopropyl methacrylamide (1). This monomer was chosen since it is a viscous liquid at room temperature (RT) and exhibits low volatility at temperatures above 65° C., making it convenient for thermal FRP by AIBN. Its corresponding polymer, Poly(3-dimethylaminopropyl methacrylamide) (P1), is a stable vinyl polymer with high glass transition temperature (about 150° C.) and a pendant amine group which we thought might provide some electrochemical functionality. A typical PL synthesis would involve the mixing of CuNP with 1 (6 wt % relative to CuNP) and AIBN (1 wt % relative to 1) in methanol in a Schlenk flask. Then, vacuum was used at RT (for 2 h) to remove methanol, leaving a CuNP presumably coated with 1 and AIBN. The Schlenk flask was then refilled with N₂, and polymerization was induced by heating to 65° C. in a sonicator bath for 12 h. Sonication was used to ensure constant dispersion of monomer in case of a speculative event where monomer sinks to the bottom or consolidates into its own phase. The final product was stored in the Schlenk flask under N₂ until further use.

In general, any PL CuNP sample was prepared alongside its PF counterpart. The method for making a PF sample was to prepare a mixture of 1 with AIBN (1 wt % relative to 1) in a known amount of solvent, usually methanol or methanol/H₂O. The mixture was prepared in a Schlenk flask and degassed with several vacuum/N₂ cycles until finally pressurized with N₂. The mixture was then heated to 65° C. for 12 h. At this point, NMR was used to confirm full conversion of monomer. If conversion was complete, a known amount of the solution corresponding to a desired mass of P1 was added to a known amount of CuNPs. The CuNP/P1/solvent mixture was sonicated for several hours before finally removing the solvent by vacuum and finally pressurized with N2 for storage until later use.

Two variations on P1 were synthesized using hexa-functionalized phosphoric acid molecule phytic acid (PA) as a dynamic crosslinker and sulfonic acid containing 2-Acrylamido-2-methylpropane sulfonic acid (AMPS) as a dynamic crosslinking comonomer. Both these variations presumably react with 1 to form conjugate acid/base pair, which form electrostatic bonds. These bonds are dynamic and do not prevent P1/PA polymers or P1/AMPS copolymers from being soluble in methanol or methanol/H₂O in the case of 1/AMPS. These samples were not extensively characterized electrochemically. However, we did characterize them by SEM and thus demonstrate that these types of alterations are available to the synthetic method and could presumably have enhanced ion conduction (and so would be interesting for this electrochemical application).

A successful PL polymerization was evaluated on the basis of H NMR and scanning electron microscopy (SEM). In the case of H NMR, 20 mg of CuNP-P1-PL was added to an NMR tube with 0.5 mL of D₂O. Polymer peaks were observed between 1 and 3 ppm. In the event of an unsuccessful polymerization, monomer peaks would be observed from 5 to 6 ppm. In terms of qualitative analysis using SEM, polymer could usually be visually observed by comparison of polymer/CuNP sample to that of blank CuNPs. The CuNPs used in this study were about 100 nm in diameter, thus high magnification (50,000 to 100,000×) was generally used.

### Electrochemical Characterization

The first samples tested were CuNP-1-PF and CuNP-1-PL at 6 wt % 1 relative to CuNP. These electrodes were spray coated onto porous carbon GDE with a loadings around 0.1-0.2 mg/cm². Electrochemical tests were performed in a 25 cm² custom cell in a zero-gap configuration. In this configuration, the Cu cathode is in direct contact with the anion exchange membrane (see FIG. 5). The anode was a Pt coated Ti mesh with layer of IrO₂ and 0.1 M KHCO₃ was recirculated at the anode. The gas inlet stream was CO₂ at 95% relative humidity and the cell temperature was 45 C.

The electrochemical CO₂RR performance of these electrodes was not spectacular but still provided valuable insight. The CuNP-1-PF sample provided a maximum 10% faradaic efficiency (FE) for ethylene production at 300 mA/cm² with lower ethylene production at higher/lower current densities. Meanwhile the CuNP-1-PL counterpart produced no ethylene at any tested current density. One possible explanation for this result is that PL methodology coats the CuNPs extremely well. So well in fact that trace or minimal CO₂ can access the Cu. Likewise, because the CuNP surface is thoroughly coated with electron-insulative polymer, the CuNPs might not be electrochemically accessible. While the produced CO is catalyzed by the Cu, the surface coverage of the CO is likely too low to promote the CO dimerization needed to form C2+ products like ethylene. The same samples (CuNP-P1-PL and CuNP-P1-PF, 6 wt %) were then rod coated onto the same GDE material. This technique allows for much higher loadings of around 1.1-1.3 mg/cm². In this case, no ethylene was produced for either PF or PL sample in a CO₂ reduction experiment. Furthermore, no CO was produced in cither sample. This is an odd result that supports the conclusion that P1 limits either the electrochemical accessibility or the mass transport of the CO₂ to the Cu surface. However, since both PF and PL samples gave similar values, this result is generally inconclusive.

Next, we performed coverage diagnostics using electrical impedance spectroscopy. Coverage metrics are quantified as a ratio of the capacitance at 10% relative humidity (RH) and 100% RH. In other words, when the CuNPs are totally soaked in water at 100% RH all of the CuNP surface area is theoretically available for electrochemical capacitance since water can easily transport ions to the Cu-surface. This total capacitance is measured experimentally with electrochemical impedance spectroscopy. Then, when the moisture is near completely removed (RH=10%) the capacitance is measured again. This second measured capacitance at RH=10 represents the Cu surface that is capable transferring charge through the polymer coating. The ratio of these two capacitances is the normalized coverage of the ionomer as it essentially normalizes the amount of Cu covered by the polymer by the total Cu surface area. The critical assumption here is that there is no pathway for ions to transport to the Cu-surface except through the polymer coating. Therefore, the ionic conductivity does somewhat affect the results. In this case, we compared the CuNP-1-PF and CuNP-1-PL samples (at 6 wt % loading) directly to each other, somewhat eliminating the ionic-conductivity variable. The result was that the CuNP-1-PF measured 5% coverage while CuNP-1-PL measured 16% coverage. This 3-fold increase is strong evidence that the PL method gives a more even and uniform polymer coating over the CuNP surface when compared to PF.

Without being limited by theory, we hypothesized that 6 wt % 1 relative to CuNP was too much loading for this polymer since it clearly does not productively facilitate electron transport and possibly blocks CO₂ from reaching the Cu surface. Thus, we decided to reduce the loading to 0.5 wt % P1 relative to CuNPs. In this case, the PL electrode was compared to a fluorinated polyethylene/polypropylene copolymer (FEP) at the same loading of 0.5 wt %. This CuNP/FEP electrode can essentially be thought of as blank CuNPs since the fluorinated polymer is highly apolar and contributes no appreciable electrochemical activity. When compared to the CuNP-FEP-PF electrode, the CuNP-1-PL electrode produces roughly half the amount of CO at all current densities. Since CO₂ reduction to CO is presumed to occur on the surface of the CuNP, and since hydrogen formation is known to occur on the carbon GDM or the Cu surface, it is fair to conclude that 1 is blocking CO₂ from interacting with CuNPs. While this blocking feature is not ideal for CO₂RR, the result speaks to the effectiveness of the PL method. The fact that CO production is cut nearly in half at even such a low polymer loading of 0.5 wt %, is evidence of an extremely even and total coating of the CuNPs by 1 during the PL process.

Lastly, we performed some electrode diagnostics for the 0.5 wt % loaded CuNP-1-PL sample compared to CuNP-FEP-PF. For this experiment, we wanted to measure the ability of ions to transport charge through the CuNPs in the electrode, which we can understand through the parameter R_{CL,OH} (Ωcm2) or the resistance to charge transfer in the catalyst layer. We have previously correlated low values of R_{CL,OH} to increased production of C₂₊ products from carbon monoxide reduction. This parameter can be influenced by the porosity of the electrode and the ionomer polymer. The electrode with 0.5% P1 gave a value of 27.1 Ω-cm2, compared to a value of 58.5 Ω-cm2 from the 0.5% FEP Teflon electrode. While the P1 electrode has increased charge transport through the catalyst layer, these values are still higher than high performing electrodes with values of <8 Ω-cm2.(ref) The discrepancy in the catalytic capability for the P1 and FEP Teflon electrode and the RCL.OH values may due to the hydrophobicity of the FEP, since hydrophobicity has been shown to promote CO₂R.

While we are disappointed that P1 is not a great polymer for facilitating CO₂RR, we are confident that the PL methodology is highly effective for producing evenly and uniformly coated CuNPs. This conclusion is reinforced by SEM qualitative analysis, coverage diagnostics through impedance spectroscopy, lack of ethylene production for CuNP-P1-PL vs CuNP-P1-PF (6wt % vs 6 wt %) in a zero gap 25 cm2 CO₂ reduction cell, and substantial reduction in CO production for CuNP-P1-PL vs CuNP-FEP-PF (0.5 wt % vs 0.5 wt %). The next logical step would be to translate this Polymer Last methodology to a polymer with higher activity for CO₂RR.

### Experimental

Materials: 46.7 wt % Pt/C catalyst (TEC10E50E, TKK) from TANAKA Precious Metals were used to fabricate the anode GDE. Cu nanoparticles (40 nm) from U.S. Research Nanomaterials was used to fabricate the cathode GDE. 27.5 um thick Nafion XL (Ion-Power Inc.) was used as the CEM and 25 μm thick Aemion+(AF2-CLE8-25-X) (Ionomr Innovations) was used as the AEM. Both membranes had reinforcement layers. The cell hardware components were the same as reported in previous publications from our group40. Nickel and titanium were used as the anode and cathode flow field materials respectively. For the KOH chamber, chemically inert polycherimide (PEI) film (McMaster Carr) were used.

KOH pellets (>85.0% Emsure from Sigma Aldrich) were used to make the KOH solution. ASTM I quality DI water (Milli-Q) was used for all purposes.

Electrode fabrication: The anode catalyst ink was prepared following established protocols by mixing 46.7 wt % Pt supported on high surface area carbon catalyst powder, 20 wt % D2020 Nafion dispersion, n-propyl alcohol, and water. The nPA to water ratio was kept 2:3 as this dispersion showed the optimal catalyst-ionomer interaction43. For application with CEM (FIG. 1a), the ionomer loading was 30% by weight (about 0.9 ionomer to carbon ratio). For application with AEM (FIG. 1b and 1c), 3 wt % ionomer loading was used (about 0.2 ionomer to carbon). The ink was horn-sonicated for 10 s. Then it was ultrasonicated for 45 minutes in an ice-water bath. Then the ink was sprayed on SGL39BB gas diffusion layer (GDL) with 5 wt % PTFE loading on the microporous layer (MPL) side by the Sono-Tek spray station with a 25 kHz accumist nozzle. The final Pt loading was 0.22±0.013 mg/cm2 as determined by X-ray fluorescence (XRF) (Fisher XDV-SDD). The spray area was approximately 50 cm².

The cathode catalyst ink was prepared by mixing 3.0 g isopropanol and 3.1 g water in a 20 mL glass vial and then adding 0.9 g Nafion D2020. While stirring this mixture with a magnetic stir bar, 3 g of Cu nanoparticles (U.S. Research Nanomaterials, 40 nm) were added. After dispersion of the particles in the solvent (1-5 min), the stir bar was removed, and 55 g of 5 mm zirconium oxide beads (Glen Mills) were added. The vial was taped and placed on a roller at 80 rpm for 19-24 hours. After milling, the ink was rod-coated onto Sigracet 39 BB by placing an approximately 5×8 cm piece of gas diffusion media onto an Automatic Film Applicator, depositing 2-3 mL of ink and rolling at 55 mm/s at room temperature with a number 25 rod. The electrodes were then transferred to an 80° C. oven for 5-10 minutes to dry.

The AEM was soaked in 1 M KOH overnight to exchange the counter ions (I− and Cl−) and to delaminate it from the backing layer.

Cell assembly: The GDEs in FIG. 1a and 1b were assembled in zero-gap configuration with two 228.6 um thick PTFE gaskets to achieve 20% compression on both anode and cathode. 25 cm2 cell area was cut from the 50 cm² sprayed area. For one setup, the Cu GDE was soaked in 1 M KOH in a container separate from the one where the AEMs were soaked.

The configuration shown in FIG. 1c was achieved in a different way. In this configuration, two electrolyte holes were drilled in the anode flow field made of nickel. Two AEMs were used, one on the anode side and the other on the cathode, to separate them from the KOH chamber. The KOH chamber was made by putting 10 PEI films (McMaster Carr), each 0.005″ thick, between the anode side and the cathode side membrane. The electrolyte KOH entered and exited the chamber through the anode flow-field holes. There was no hole for KOH to go through and wet the Cu GDE. The only way KOH could reach the Cu GDE is by crossing through the AEM. This setup mimicked the condition in a zero-gap CO₂ electrolyzer. The cell design is very similar to that used in the study from our group where a CO₂ electrolyzer cell with a catholyte container was designed for high formate production. The difference in our case was that we created a chamber to circulate an anolyte rather than a catholyte.

### Electrochemical Diagnostics:

Gas flow conditions: The cells that had no KOH in them were subjected to the same electrochemical protocol. After assembly, they were connected with a Hydrogex fuel cell test station. All the experiments were done at 60C. Nafion is known to be stable at 80° C. but not the AEMs. The official documentation of Acmion membranes recommend using a temperature below 80° C. At 60° C., the lowest RH we could go to is 20%. After setting the temperature and the initial cathode RH (20%), the gas flows (100% H₂ at anode N₂ at cathode). The cathode RH was changed from the lowest (20%) to the highest (100%). The anode RH was kept constant 100% because at very low RH, the ionic conductivity in the anode decreased significantly. A significant overpotential developed at the anode as a result.

The gas backpressure was kept 100 kPa and the flow rate was 0.2 SLPM. The total backpressure was adjusted to maintain the 100 kPa gas pressure. At 60° C., the saturated vapor pressure of water is 20 kPa So, for certain cathode RH, total gas backpressure=100 kPa+RH/100*20 kPa. The anode backpressure was kept constant at 120 kPa. At low cathode RH, some water vapor may have crossed over to the cathode due to this pressure differential. However, stable EIS curves were obtained for each RH.

For the setup where the electrode was soaked in KOH, a slightly different protocol was used. After assembly, the cathode RH was set to 100% and conditioned. If the RH was low, then KOH would be purged out easily due to evaporation. We performed only one experiment in this condition as KOH gets purged slowly from the system.

For the setup with KOH flow (FIG. 1c), a different protocol was used. This test was done in a custom-built electrochemical test station that is equipped with a strong chemical exhaust hood. The reasons to use a different test station are—1) when both H2 is flowing in the anode and the KOH is being circulated, some H₂ comes out in the KOH bottle. Some KOH drops also come out through the H2 outlets. They got mixed. So, we needed a strong hood for ventilation. 2) The KOH could go inside the fuel cell test controllers and damage the sensors. Because of the design of CO₂ test stations, we could not pressurize the H₂ gas. So, the gases (both H₂ and N₂) were not pressurized. Lower gas flow rate (0.2 SLPM) was used. KOH was circulated at 20 mL/min using an electrolyte pump. The RH control was also different from that in the fuel cell test station. At that low flow rates, we could only use very low RH (0%) or very high RH (95% or above). So, the measurements were done at 2 RH values. We could not increase the gas flow rates because of three reasons—1) it tore the membranes due to the increased pressures, and 2) it flushed out KOH quicker than it could be refilled creating a void in the KOH container, 3) high gas flow rates created turbulence in the KOH chamber that made the EIS data noisy.

Conditioning: The electrode was conditioned in the OCV condition with H₂/N₂ gas feed (flow rate and backpressure as mentioned above) for 1 hour at each RH. When a CEM was used, the initial OCV was around 260 mV and later dropped to 150 mV. The dissolution potential for Cu is about 182 mV vs standard hydrogen electrode (SHE) for pH <5. Assuming the local pH at the anode to be ˜245, the potential on Cu electrode was 260−59*2 =142 mV vs SHE. So, the OCV condition was most likely a safe potential even in presence of internal currents. With just an AEM (no KOH), the initial OCV was found to be around 300 mV. This is expected as the anode potential shifted to a more negative value with respect to an SHE with increasing pH.

The setup with KOH flow (FIG. 1c) was conditioned in a similar way. KOH flow was started as soon as the cell was assembled. It was done to prevent membrane drying. Then the temperature was set, and the gas flow was initiated. Then the system was left to equilibrate for 30 mins before any EIS experiments were performed. The initial EIS was about 550 mV which, after equilibration, went down to 450 mV. The KOH also crossed over to Pt/C and increased the internal pH. So, the anode was effectively at a lower potential (vs SHE) than the setup with just an AEM but no KOH flow. Due to KOH, the Cu particles might have been slightly oxidized.

EIS protocol: Potentiostatic EIS was performed at 100 mV cell voltage with 20 mV root mean square AC perturbation for all setups. The potential was chosen for the following reasons—1) The potential must be greater than 0 to minimize the effect of HER, 2) the potential must be less than the dissolution potential, 3) it should be close to potential of zero charge for Cu to avoid effects of physisorption or chemisorption (surface oxides or complexes). Pourbaix diagram for Cu indicates that in acidic environment, planar Cu dissolves at ˜182 mV vs SHE at 25° C. The average Cu catalyst particles size was 40 nm, which reduces the dissolution potential due to the Gibbs-Thomson effect by:

$$μ ( r ) = μ ( r = ∞ ) - \frac{2 {γ}_{Cu} {V}_{Cu}}{r}$$

Where μ(r) and μ(r=∞) are the chemical potentials of Cu in particle form (of radius ‘r’) planar form respectively. γCu is the surface free energy of Cu and VCu is its molar volume. γCu=1.756 J/m² at 358 K and VCu=7.11 cm³/mol. From here, one can calculate the dissolution potential for the particle to be:

$${E}_{diss} ( r ) = {E}_{diss} ( r = ∞ ) - \frac{Δ μ}{zF} = 182 - 6.48 mV = 175.52 mV$$

Here, z=1. The correction due to Gibbs-Thompson effect for 40 nm particles is negligible. This effect is stronger for smaller nanoparticles, for example, in Pt/C electrodes, as the Pt particles are about 3 nm in size.

The potential of zero charge (PZC) for polycrystalline Cu is approximately −640 mV vs SHE around pH 348. Assuming the local pH at anode to be about 2, the potential at the anode was about 0−59*2=−118 mV vs SHE. So, in order to apply a potential close to PZC, we had to apply negative cell potential. But that would produce HER. So, there was no way to choose a potential close to PZC and avoid HER at the same time. So, we neglected the criterion number 3. Due to this problem, the surface charge on Cu was most likely different in different setups. For example, with CEM, the surface charge was highly negative. With AEM and KOH flow, the surface charge was less negative (as the anode potential was more negative). Ideally, different capacitance curves should be considered at similar charging conditions, as according to the Gouy-Chapman-Stern theory, the differential double layer capacitance (CDL) depending on the surface charge. Sheet capacitance is the product of CDL and electrochemical active area. If CDL changes in different setups, one cannot have an apple-to-apple comparison.

The frequency range was chosen from 300 kHz to 0.1 Hz. We used Gamry 3000 potentiostat (both with and without the booster). 300 kHz is the maximum frequency that the potentiostat can generate. We did not go below 0.1 Hz to avoid any low frequency apparent inductive behavior49,50. The ‘normal’ data acquisition mode was chosen. 20 mV AC perturbation was chosen as it was the maximum perturbation potential which satisfied the Kramers-Kronig (KK) criterion, and hence, satisfied linearity, causality, and stability51. The internal Gamry code for KK test was used for this.

### Micro Xray Tomography (Micro XCT)

The GDE catalyst layer thickness is quantified with a micro Xray computed tomography instrument (micro XCT, NSI X3000, North Star Imaging, Inc. USA.) During the characterization, the X-ray source has a voltage of 80 kV and emission current of 250 μA. The GDE sample was mounted on the rotation stage and rotated for 360 degrees during the full acquisition. 1080 projections were taken during the scan with 30 frames averaged for each projection. Details of the technique are reported elsewhere52.

### Conclusions

Herein, an experimental method to study the morphology of CO₂ reduction electrodes without the complexities of co-electrolysis of a CO₂ electrolyzer was developed. This study showed that flowing anolyte in zero-gap CO₂R devices improves the morphology of the cathode by increasing the catalyst utilization as well as the ionic conductivity. We used an unsupported Cu gas diffusion electrode with low Nafion content as the model electrode and 1 M KOH as the anolyte. We found, by comparing the electrochemical data in presence and absence of anolyte, that the electrochemically active area and ionic conductivity inside the electrode increased 4 and 447 times respectively. Liquid anolyte wetted the electrode's pore space more efficiently than the capillary condensed water vapor could. Surface ion conduction (both H+ and OH−) was orders of magnitude weaker than the ion-conduction inside bulk KOH. The ionomer coverage was very low (about 4%) and its distribution was highly fragmented (tortuosity about 19 at maximum hydration). With the present state of commercially available ionomer binders, our study indicates that an anolyte flow is essential not only for the electrolyzer anode and the anion exchange membrane, but also for the cathode. The method developed in this study can be utilized to optimize CO₂ reduction processes targeting a variety of products.

### Ion-Conducting Polymers and Development of Polymer Structure-Property Relations

In an embodiment, methods and compositions disclosed herein are useful for synthesizing and characterizing a series of Ion-Conducting Polymers.

In an embodiment, coat polymers are synthesized on copper electrodes and assess coating quality, conformability and electrochemical activity

In an embodiment, in-situ polymerization of several compositions are performed and the characterization and assessment is carried out.

In another embodiment, an in-situ deposition-polymerization process using higher performance functional groups (sulfonic or phosphonic acid-functional monomers) is performed.

The embodiments described herein should not necessarily be construed as limited to addressing any of the particular problems or deficiencies discussed herein. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods, and devices useful for the present methods can include a large number of optional composition and processing elements and steps.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A process for the electrochemical CO₂ reduction to capture and convert CO₂ to valuable chemicals.

2. A method for coating polymers that are synthesized on copper electrodes and to assess coating quality, conformability and electrochemical activity.

3. The method of claim 2 wherein in-situ polymerization of several compositions are performed and the characterization and assessment is carried out.

4. The method of claim 2 wherein in-situ deposition-polymerization process using higher performance functional groups such as sulfonic or phosphonic acid-functional monomers is performed.
